(19) United States
(12) Patent Application Publication
(10) Pub. No.: US 2010/0266756 A1
(43) Pub. Date: Oct. 21, 2010

(54) LINE STRIPER WITH AUTOMATIC LAYOUT

(76) Inventors: Jon M. Knutson, Maple Grove, MN (US); James C. Schroeder, Ramsey, MN (US); Michael J. Manshelm, Burnsville, MN (US); Jason Christensen, Inver Grove Heighls, MN (US); Robert J. Gundersen, Olsego, MN (US)

Correspondence Address: GRACO MINNESOTA INC, PO BOX 1441, MINNEAPOLIS, MN, 55440, US

(21) Appl. No.: 12/599,542

(22) PCT Filed: May 22, 2008
(86) PCT No.: PCT/US08/64546

§ 371 Date: Jun. 25, 2010

Related U.S. Application Data
(60) Provisional application No. 60/939,954, filed on May 24, 2007.

(51) Int. Cl. E01C 19/17; B05C 11/00

(52) U.S. Cl. 427/137; 118/699

(57) ABSTRACT

A line striper 10 is equipped with additional features: including a speed/distance sensor 1 delivering high resolution and recognizing reverse movement. Also included is a built in programmable control 2 for setting parking stall or road line parameters including a measuring system. A device 3 applies paint marks (dots), or equivalent onto a surface. The striper 10 can hold a paint can 5 as a means of marking. An electrical thumb switch 4 is provided at the left handle bar. A speed compensating control provides intelligence to advance and retard the timing of actuation of the dot marking apparatus providing accuracy at any speed or direction.

### TECHNICAL FIELD

This application claims the benefit of U.S. application Ser. No. 60/939,954, filed May 24, 2007, the contents of which are hereby incorporated by reference.

### BACKGROUND ART

Walk-behind (and self-propelled) line stripers are well known but heretofore have required substantial operator measurement, calculation and layout of the area to be striped.

DISCLOSURE OF THE INVENTION

This invention simplifies the layout process making it more accurate and less labor intensive. This layout capability is completely integrated into the line striper, which has never been accomplished to date.

A line striper such as Graco's LineLazer™ is equipped with additional features: including a quadrature speed/distance sensor delivering 4× the current resolution and recognizing reverse movement. Also included is a built in programmable control for setting parking stall or road line parameters including a measuring system. A device applies paint marks (dots), or equivalent, onto a surface. The striper can hold a paint can as a means of marking. It can also be accomplished through the use of the on board paint system and gun, an additional paint gun system, chalk stick, shooting device that would use chalk balls, paint balls or similar to make a mark. An electrical thumb switch is provided at the left handle bar. A speed compensating control provides intelligence to advance and retard the timing of actuation of the dot marking apparatus providing accuracy at any speed or direction.

For parking lot layout, the operator enters parking stall size and the striper system applies precision marks (dots) at the beginning and end of each parking stall line prior to painting the line. The system can also measure a desired area and automatically calculate number of stalls, or stall width to fit a set number of stalls. The system takes into account angle parking. For road line layout, the system will apply accurate skip lines on drive surfaces by entering skip length and space length. The system applies precision marks (dots) at the beginning and end of each skip. By utilizing the rear gun mount on the line striper, skips can be simultaneously applied while the marks (dots) are applied out front of line striper. This means of applying skips with a walk behind striper is extremely versatile and unique relative to prior art devices, and keeps equipment size and cost to a minimum.

The measuring: system can measure, record measurements, and apply marks (dots) to surfaces for aiding layout or construction of parking lots, roadways, airport runways, and/or any surface for that matter. The system is designed to compensate for any variations in manufacturing, design or environmental conditions. This is accomplished through calibration of the unit before operational layout using the on board control and mechanical pointer and marking device.

There are a number of advantages afforded by the striper of the instant invention including less fatigue—manual layout consists of intense walking and bending and is virtually eliminated. Also provided is one-person operation—layout typically requires more than one person. Also provided is accuracy for producing any stall size, angle parking, roadway skips, airport runways, or any surface layout with precision. Use of the instant invention with a self-propelling module such as Graco's LineDriver™ can make the job even faster

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is a perspective view showing the line striper of the instant invention.

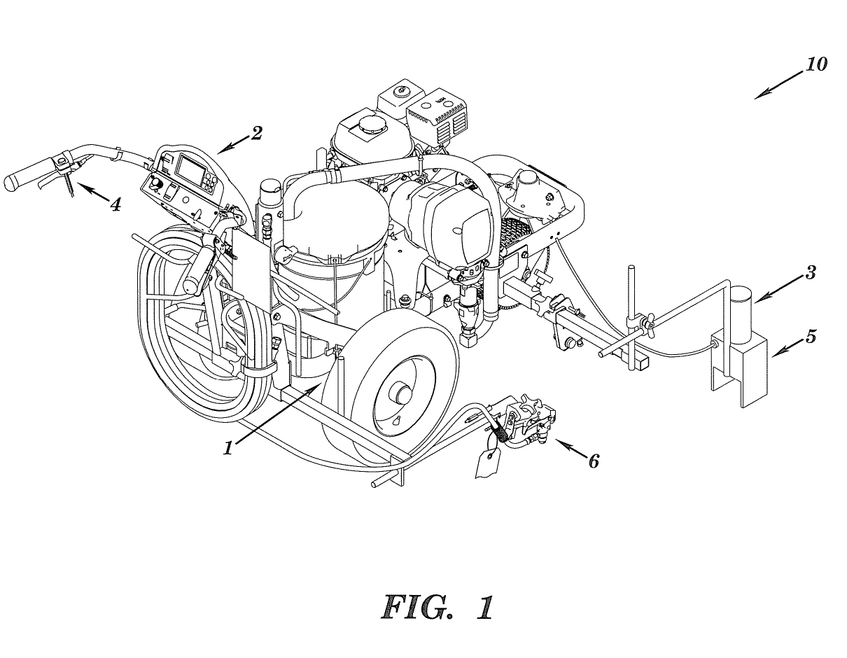

FIG. 2 is a front view of the instant invention.

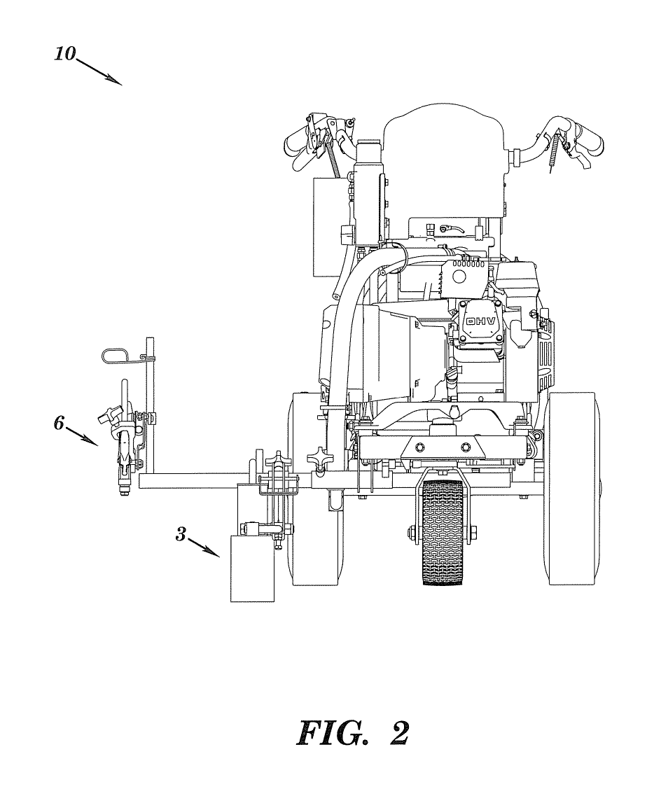

FIG. 3 is a detail view of the marker/dot applier.

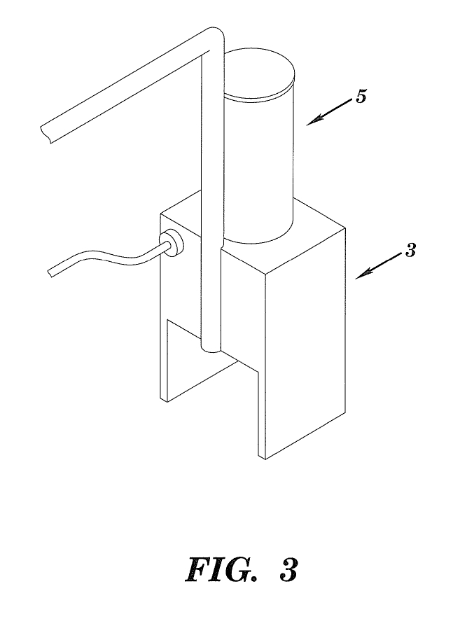

FIG. 4 is a view of the control panel and menu system.

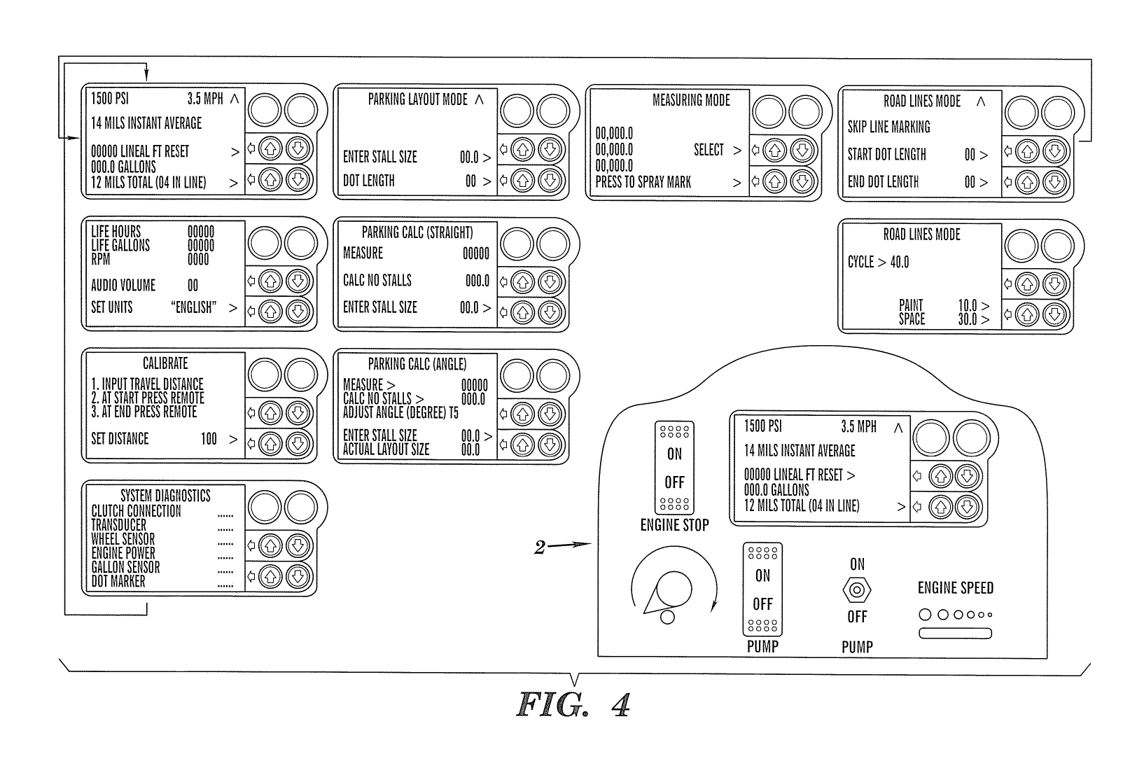

### BEST MODE FOR CARRYING OUT THE INVENTION

A line striper 10 such as Graco's LineLazer™ is equipped with additional features: including a quadrature speed/distance sensor 1 delivering high resolution and recognizing reverse movement. Also included is a built in programmable control 2 for setting parking stall or road line parameters including a measuring system. A device 3 applies paint marks (dots), or equivalent, onto a surface. The striper 10 can hold a paint can 5 as a means of marking. It can also be accomplished through the use of the on board paint system and gun 6, an additional paint gun system, chalk stick, shooting device that would use chalk balls, paint balls or similar to make a mark. An electrical thumb switch 4 is provided at the left handle bar.

For parking lot layout, the operator enters parking stall size and the striper system applies precision marks (dots) at the beginning and end of each parking stall line prior to painting the line. The system can also measure a desired area and automatically calculate number of stalls, or stall width to fit a set number of stalls. The system takes into account angle parking. For road line layout, the system will apply accurate skip lines on drive surfaces by entering skip length and space length. The system applies precision marks (dots) at the beginning and end of each skip. By utilizing the rear gun mount on the line striper, skips can be simultaneously applied while the marks (dots) are applied out front of line striper. This means of applying skips with a walk behind striper is extremely versatile and unique relative to prior art devices, and keeps equipment size and cost to a minimum.

A speed compensating control provides intelligence to advance and retard the timing of actuation of the dot marking apparatus providing accuracy at any speed or direction. This is done using a built in (software) feature that monitors the striper speed, launching the dot marking early if necessary based on the time it takes the material to leave the spray can and reach the ground. The faster the speed, the earlier the material has to leave the spray can. This is referred to as the anticipation factor.

The measuring: system can measure, record measurements, and apply marks (dots) to surfaces for aiding layout or construction of parking lots, roadways, airport runways, and/or any surface for that matter. The system is designed to compensate for any variations in manufacturing, design or environmental conditions. This is accomplished through calibration of the unit before operational layout using the on board control and mechanical pointer and marking device.

It is contemplated that various changes and modifications may be made to the striper without departing from the spirit and scope of the invention as defined by the following claims.

1. A line striper for the application of striping materials comprising:
a frame;
at least three wheels rotatably mounted on said frame;
a speed/distance sensor operably mounted to one of said wheels;
a spray device for applying paint marks; and
a control for actuating said spray device at predetermined distance intervals upon traveling a predetermined distance as measured by said speed/distance sensor.

2. The line striper of claim 1 wherein said control is capable of varying the timing o said actuation as a function of the speed measured by said speed/distance sensor.

3. A method of striping a parking lot comprising the steps of:
utilizing a line striper having a control, a speed/distance sensor and a spray device for applying paint marks;
setting said control for a predetermined distance between stripes;
propelling said striper with said control activating said spray device to produce marks, each mark being spaced said predetermined distance from another as measured by said speed/distance sensor; and
marking a stripe at each location of a mark.
